(19) United States
(12) Patent Application Publication
(10) Pub. No.: US 2012/0248791 A1
(43) Pub. Date: Oct. 4, 2012

(54) Engaging Module

(75) Inventor: Ho-Li Chu, Taipei (TW)

(73) Assignee: PEGATRON CORPORATION, Taipei City (TW)

(21) Appl. No.: 13/433,436

(22) Filed: Mar. 29, 2012

(30) Foreign Application Priority Data
Mar. 30, 2011 (TW) 100111054

(51) Int. Cl. E05C 19/10

(52) U.S. Cl. 292/128; 292/101

(57) ABSTRACT

An engaging module is used for engaging a cover to a housing. The housing includes a sliding chute extended along a direction. The engaging module includes a sliding member and a hook. The sliding member is slidable between an opening position and a closing position in the sliding chute. The sliding member includes a latch including a first guiding surface and a second guiding surface. When the cover is engaged to the housing, the sliding member may be moved to the opening position along the direction to make the first guiding surface of the latch push the cover to separate from the housing. When it is desired to engage the cover to the housing, the hook is pushed toward the second guiding surface, the sliding member is moved from the closing position along the direction, and the sliding member is moved toward the closing position so that the latch is engaged to the trough of the hook.

### RELATED APPLICATIONS

This application claims priority to Taiwan Application Serial Number 100111054, filed Mar. 30, 2011, which is herein incorporated by reference.

### BACKGROUND

1. Field of Invention

The disclosure relates to an engaging module, and more particularly, to an engaging module capable of saving space and which is easy to use.

2. Description of Related Art

In line with industry and commerce trends in which business is conducted in a more frequent and intimate manner, a large number of electronic products (i.e., portable electronic apparatus) which are lightweight, thin, short, and compact are continuously being developed. For these reasons, there are strict limitations in the utilization of space with such electronic products. As a result, the additional design of an operating mechanism and method involving the use of a button to unlock a cover of an electronic product at a location outside the cover may encounter severe restrictions with respect to space design and thus limit its scope of application.

An electronic apparatus (e.g., a mobile phone, PDA, notebook computer, etc.) generally has a housing. The housing is primarily used to encase electronic components in the electronic apparatus, so as to provide protection for the electronic components and avoid the occurrence of collision damage. A conventional approach that enables a cover (e.g., cap, door, etc.) to perform locking and releasing operations relative to a base involves engaging the cover with an engaging member on the base. A releasing button can be disposed near the cover on the base. The releasing button and the cover are typically independent components. When a user closes the cover on the base, the cover pushes the engaging member away before being locked. When the user presses the releasing button, the releasing button pushes the engaging member away so as to release the locking state between the cover and the engaging member. Furthermore, after the user opens the cover and releases the releasing button, the engaging member returns to its original position.

### SUMMARY

The embodiment of the invention provides an improved engaging module. Guiding surfaces that are capable of sliding relative to each other are disposed between a cover and the engaging module, and a component force generated from the guiding surfaces can make a sliding member of the engaging module move to an opening position or a closing position. Through such a configuration, the cover locks to or is released from the housing in a smooth and precise manner.

According to an embodiment of the invention, an engaging module is used for engaging a cover to a housing. The housing has a sliding chute. The sliding chute is extended along a direction. The engaging module includes a sliding member and a hook. The sliding member is slidable between an opening position and a closing position in the sliding chute. The sliding member includes a latch. The latch includes a first guiding surface and a second guiding surface. When the cover is engaged to the housing, the sliding member can be moved to the opening position along the direction to make the first guiding surface of the latch push the cover to separate from the housing. The hook is disposed on the cover and includes a trough. The cover can be engaged to the housing by pushing the hook toward the second guiding surface, moving the sliding member out of the closing position along the direction, and then moving the sliding member toward the closing position so that the latch is engaged to the trough.

According to an embodiment of the invention, an engaging module is used for engaging a cover to a housing. The housing has a sliding chute. The sliding chute is extended along a direction. A side of the cover is pivotally connected to the housing. The engaging module includes a sliding member, a third guiding surface, a retaining portion, a resilient member, and a hook. The sliding member is slidable between an opening position and a closing position in the sliding chute. The sliding member includes a latch. The latch includes a first guiding surface and a second guiding surface. The third guiding surface is disposed on the cover. When the cover is engaged to the housing, the sliding member can be moved to the opening position along the direction to make the first guiding surface of the latch push the third guiding surface so as to push the cover to separate from the housing. The first guiding surface is parallel to the third guiding surface. The retaining portion is disposed on the cover. The latch abuts against the retaining portion, so that the sliding member is located at the opening position. The resilient member is disposed in the sliding chute between the housing and the sliding member for pushing the sliding member, so that the sliding member is located at the closing position. The hook is disposed on the cover. The hook includes a fourth guiding surface, a trough, and a guiding angle. The cover can be engaged to the housing by pushing the fourth guiding surface of the hook toward the second guiding surface and moving the sliding member out of the closing position along the direction. The fourth guiding surface is parallel to the second guiding surface. The sliding member moves toward the closing position to make the latch be engaged to the trough after the cover is engaged to the housing. The guiding angle is disposed at the edge of the fourth guiding surface for easing the friction between the fourth guiding surface and the second guiding surface.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A is a perspective view of an electronic apparatus that includes an engaging module according to an embodiment of the invention, in which a cover of the electronic apparatus is shown in a state engaged to a housing of the electronic apparatus;

FIG. 1B is a partial enlarged view of the housing in FIG. 1A;

FIG. 2A is a partial side view of the electronic apparatus in FIG. 1A, in which a sliding member is shown in a state located at a closing position, and a hook of the engaging module is shown in a state not yet contacted with a latch;

FIG. 2B is a partial side view of the electronic apparatus in FIG. 1A, in which the hook of the engaging module is shown in a state pushing the latch to make the sliding member leave the closing position;

FIG. 2C is a partial side view of the electronic apparatus in FIG. 1A, in which the hook of the engaging module is shown in a state engaged to the latch on the sliding member;

FIG. 2D is a partial side view of the electronic apparatus in FIG. 1A, in which the latch on the sliding member is shown in a state just contacting the cover;

FIG. 2E is a partial side view of the electronic apparatus in FIG. 1A, in which the sliding member is shown in a state located at an opening position, and the latch is shown in a state pushing the cover to separate from the housing; and

FIG. 3 is a partial sectional view of the hook in FIG. 2A taken along line 3-3.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

An improved engaging module is provided. More specifically, guiding surfaces that are capable of sliding relative to each other are disposed between a cover and the engaging module, and a component force generated from the guiding surfaces can make a sliding member of the engaging module move to an opening position or a closing position. Through such a configuration, the cover locks to or is released from the housing in a smooth and precise manner.

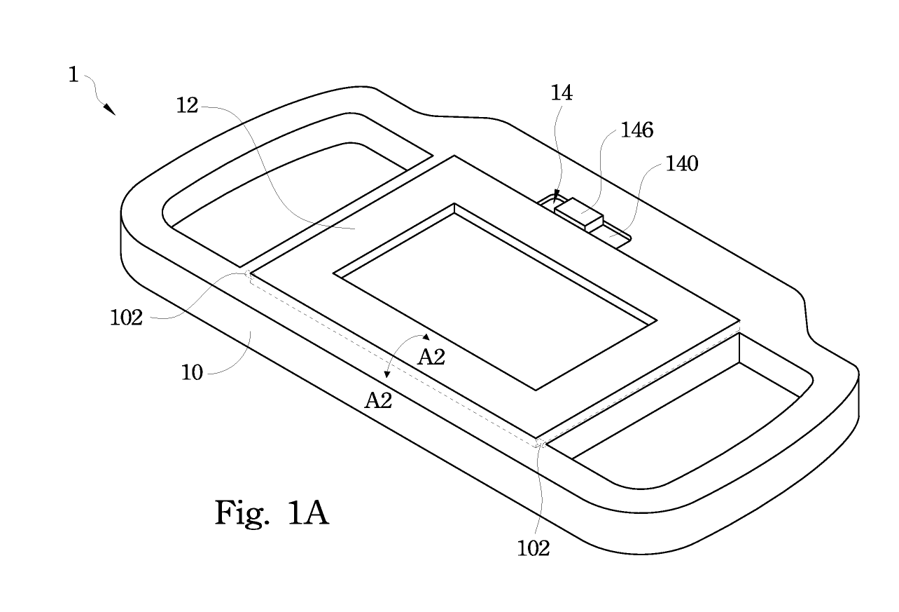

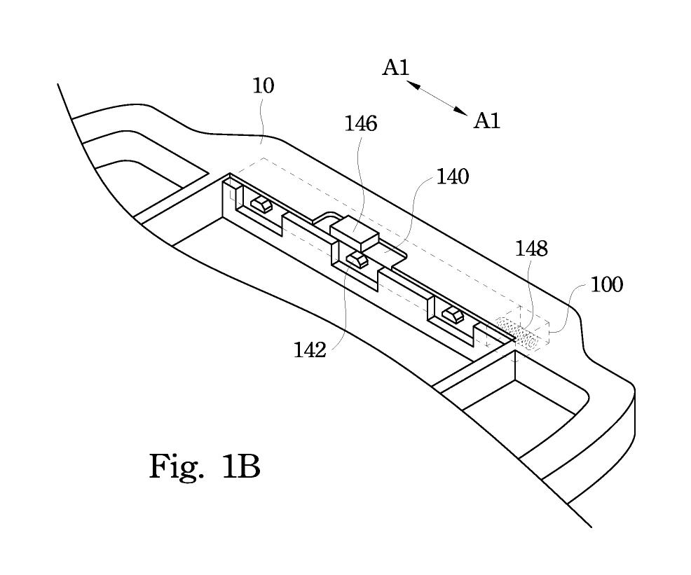

FIG. 1A is a perspective view of an electronic apparatus 1 that includes an engaging module 14 according to an embodiment of the invention, in which a cover 12 of the electronic apparatus 1 is shown in a state engaged to a housing 10 of the electronic apparatus 1. FIG. 1B is a partial enlarged view of the housing 10 in FIG. 1A.

As shown in FIG. 1A and FIG. 1B, the electronic apparatus 1 that applies the engaging module 14 of the invention can be a portable electronic apparatus (e.g., a mobile phone, PDA, GPS, etc.) or a game console (e.g., the Sony PSP, Nintendo NDSL, etc.), but the invention is not limited in this regard. That is, the electronic apparatus 1 that applies the engaging module 14 of the invention can be any electronic product having a cover. As long as there is a requirement to make the cover perform the functions of locking to or releasing from a main body of the electronic product, the concepts of the engaging module 14 of the invention can be applied to the electronic product.

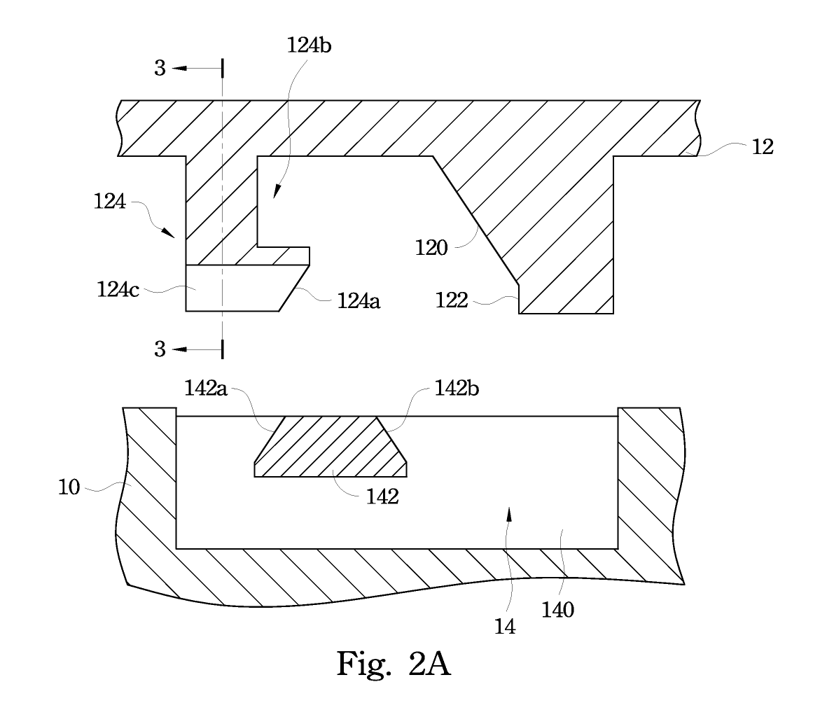

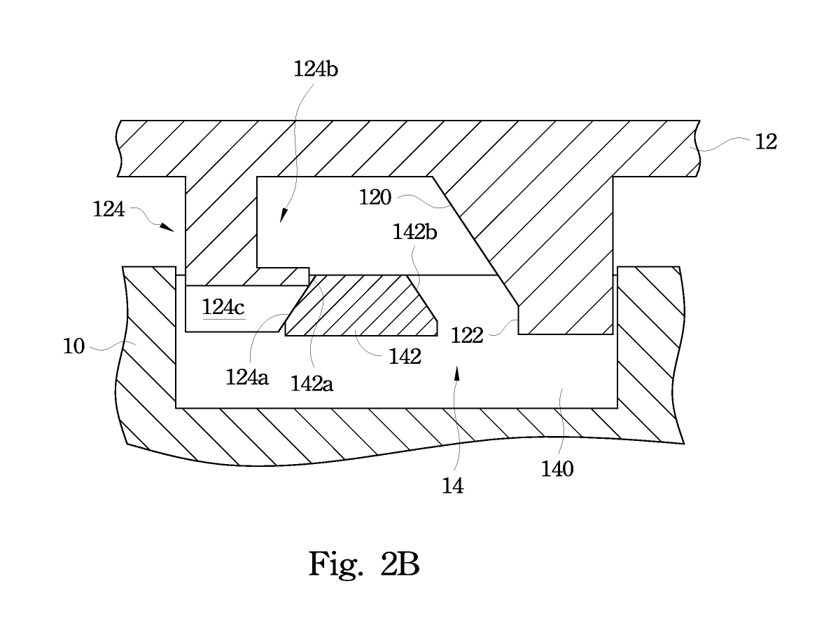

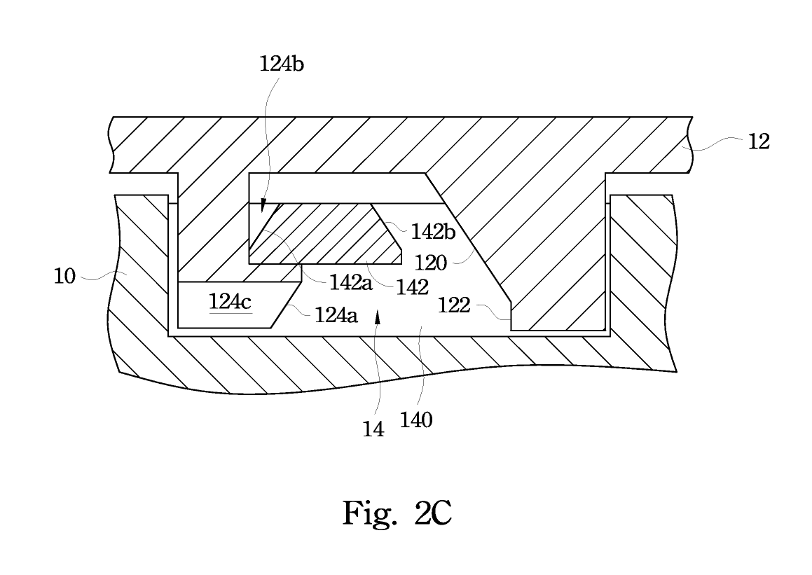

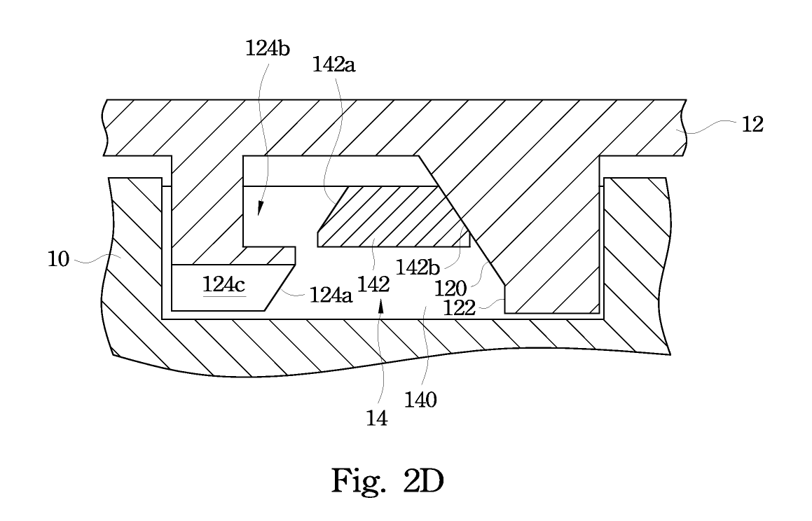

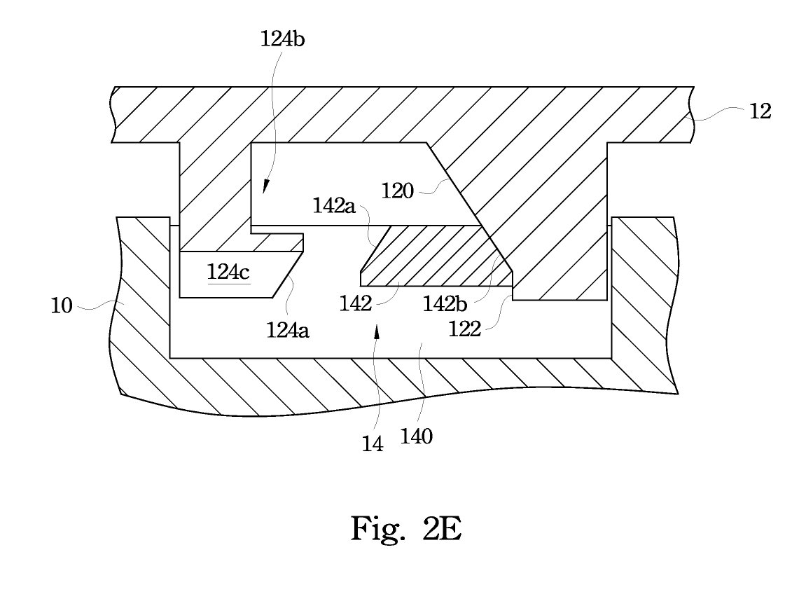

As shown in FIG. 1A and FIG. 1B, the electronic apparatus 1 includes the housing 10, the cover 12, and the engaging module 14. The housing 10 has a sliding chute 100, and the sliding chute 100 is extended along a direction A1. The cover 12 can be used to engage to the housing 10. The engaging module 14 includes a sliding member 140. The sliding member 140 is slidable between an opening position and a closing position in the sliding chute 100 of the housing 10. The sliding member 140 includes a latch 142 and a pushing button 146. The pushing button 146 can be pressed to force the sliding member 140 to slide in the sliding chute 100. Although the sliding member 140 is shown in FIG. 1B as including more than one latch 142, the number thereof can be adjusted according to design requirements or manufacturing limitations and is not limited to that shown in FIG. 1 B. The structures and functions of components in the electronic apparatus 1 will be introduced and described in detail below. The exact locations of the components in the opening position and the closing position and their relative arrangement can be understood by referring FIG. 2A to FIG. 2E and the corresponding description.

FIG. 2A is a partial side view of the electronic apparatus 1 in FIG. 1A, in which the sliding member 140 is shown in a state located at the closing position, and a hook 124 of the engaging module 14 is shown in a state not yet contacted with the latch 142. FIG. 2B is a partial side view of the electronic apparatus 1 in FIG. 1A, in which the hook 124 of the engaging module 14 is shown in a state pushing the latch 142 to make the sliding member 140 leave the closing position. FIG. 2C is a partial side view of the electronic apparatus 1 in FIG. 1A, in which the hook 124 of the engaging module 14 is shown in a state engaged to the latch 142 on the sliding member 140. FIG. 2D is a partial side view of the electronic apparatus 1 in FIG. 1A, in which the latch 142 on the sliding member 140 is shown in a state just contacting the cover 12. FIG. 2E is a partial side view of the electronic apparatus 1 in FIG. 1A, in which the sliding member 140 is shown in a state located at the opening position, and the latch 142 is shown in a state pushing the cover 12 to separate from the housing 10.

As shown in FIG. 2A, the engaging module 14 further includes the hook 124, and the hook 124 is disposed on the cover 12. In the state shown in FIG. 2A, the hook 124 of the engaging module 14 has not contacted the latch 142 of the sliding member 140, and the sliding member 140 is located at the closing position. In order to locate the sliding member 140 at the closing position when the hook 124 of the engaging module 14 has not contacted the latch 142, the electronic apparatus 1 can further include a resilient member 148 (see FIG. 1B). The resilient member 148 can be disposed in the sliding chute 100 of the housing 10 and between the sliding chute 100 (i.e., a side wall of the housing 10 forming the sliding chute 100) and the sliding member 140. Therefore, the resilient member 148 can be used to push the sliding member 140 along the direction A1, so that the sliding member 140 is located at the closing position whenever a sufficient force in the opposite direction is not applied thereto. In other words, when the hook 124 of the engaging module 14 is not in contact with the latch 142 of the sliding member 140, the resilient member 148 pushes the sliding member 140 so that it is located at the closing position. At this time, a side of the sliding member 140 is pushed by the resilient member 148, and another side of the sliding member 140 abuts against an end of the sliding chute 100 of the housing 10 (i.e., a side wall of the housing 10 forming the sliding chute 100 opposite the side wall against which the resilient member 148 abuts). In an embodiment, the resilient member 148 can be a spring, but the invention is not limited in this regard. The resilient member 148 can be made from elastic materials (e.g., rubber) or can be made of a spring component (e.g., a spring plate, torsion spring, etc.).

As shown in FIG. 2B, in order to enable the hook 124 to smoothly slide relative to the latch 142 on the sliding member 140, the hook 124 of the engaging module 14 can include a fourth guiding surface 124a. With this configuration, the hook 124 can smoothly push the latch 142 on the sliding member 140 with the fourth guiding surface 124a, so as to make the latch 142 slide relative to the fourth guiding surface 124a and thus make the sliding member 140 leave the closing position. Similarly, in order to enable the hook 124 to smoothly slide relative to the latch 142 on the sliding member 140, the latch 142 can include a second guiding surface 142a corresponding to the fourth guiding surface 124a of the hook 124. The fourth guiding surface 124a can be parallel to the second guiding surface 142a, and the fourth guiding surface 124a and the second guiding surface 142a are not perpendicular to the direction A1. With this configuration, the second guiding surface 142a of the latch 142 can be smoothly pushed by the fourth guiding surface 124a of the hook 124. In an embodiment, if it is desired only to achieve the basic requirement of making the hook 124 push the latch 142 to make the sliding member 140 leave the closing position along the direction A1, a configuration may be used in which only the fourth guiding surface 124a is disposed on the hook 124 or only the second guiding surface 142a is disposed on the latch 142 of the sliding member 140.

As shown in FIG. 2C, the hook 124 of the engaging member 14 can further include a trough 124b. The latch 142 of the sliding member 140 can engage the trough 124b. After the cover 12 is completely closed, during which process the hook 124 in FIG. 2B downwardly pushes the latch 142 of the sliding member 140, the sliding member 140 that is pushed away from the closing position by the hook 124 will be pushed by in the opposite direction by the resilient member 148, so as to make the latch 142 of the sliding member 140 engage the trough 124b of the hook 124. In this state, the cover 12 is prevented from separating from the housing 10.

As shown in FIG. 2D, if it is desired to disengage the hook 124 from the trough 124b, a user can push the pushing button 146 of the sliding member 140 to make the sliding member 140 slide along the sliding chute 100 and thereby make the latch 142 disengage from the trough 124b of the hook 124. During this operation, the sliding member 140 compresses the resilient member 148. In the embodiment, if the pushing button 146 of the sliding member 140 is continuously pushed to make the sliding member 140 slide along the sliding chute 100, the latch 142 of the sliding member 140 will contact the cover 12. In this initial state, the sliding member 140 has not reached the opening position, as shown in FIG. 2D.

As shown in FIG. 2E, if it is desired to make the sliding member 140 reach the opening position, the user can continuously push the pushing button 146 of the sliding member 140, so as to push the sliding member 140 and force the same to continue to slide until reaching the opening position. During this operation, the cover 12 is pushed so that it separates from the housing 10. In the embodiment, in order to enable the latch 142 of the sliding member 140 to smoothly slide relative to the cover 12, the latch 142 of the sliding member 140 further includes a first guiding surface 142b. Through this configuration, the latch 142 of the sliding member 140 can smoothly push the cover 12 using the first guiding surface 142b thereof, so that the sliding member 140 can reach the opening position and make the cover 12 separate from the housing 10 at the same time. To further enhance the smooth sliding of the latch 142 of the sliding member 140 relative to the cover 12, the cover 12 further includes a third guiding surface 120 corresponding to the first guiding surface 142b. The first guiding surface 142b can be parallel to the third guiding surface 120, and the first guiding surface 142b and the third guiding surface 120 are not perpendicular to the direction A1. With this configuration, the third guiding surface 120 of the cover 12 can be smoothly pushed by the first guiding surface 142b of the latch 142. In an embodiment, if it is desired only to achieve the basic requirement of making the latch 142 push the cover 12 to make the sliding member 140 reach the opening position, a configuration may be used in which only the first guiding surface 142b is disposed on the latch 142 or only the third guiding surface 120 is disposed on the cover 12.

Furthermore, in order to precisely stop the sliding member 140 at the opening position, the cover 12 can further include a retaining portion 122. The latch 142 of the sliding member 140 can abut against the retaining portion 122 of the cover 12. The retaining portion 122 of the cover 12 can be connected to the third guiding surface 120. Therefore, no matter how hard the pushing button 146 of the sliding member 140 is pushed, the sliding member 140 can only be moved as far as the opening position when the first guiding surface 142b of the latch 142 slides relative to the third guiding surface 120. In other words, when the first guiding surface 142b of the latch 142 continuously pushes the third guiding surface 120 of the cover 12, the retaining portion 122 will stop the latch 142 from continuously moving along the direction A1. When the latch 142 reaches the retaining portion 122, the sliding member 140 is located at the opening position.

In the embodiment, with reference to FIG. 1A, a side of the cover 12 is pivotally connected to the housing 10 through a pivot 102, so that the cover 12 can rotate relative to the housing 10 along a direction A2. With this configuration, the cover 12 can be rotated to close relative to the housing 10 using the pivot 102 on one side of the cover, and the engaging module 14 can be disposed at a location corresponding to the other side of the cover 12, but the invention is not limited in this regard. In another embodiment, two engaging modules 14 are disposed between the cover 12 and the housing 10, so that the cover 12 can be perpendicularly assembled to the housing 10.

In the embodiment, because one side of the cover 12 is pivotally connected to the housing 10, a situation in which uneven friction is applied to the engaging module 14 may occur when the cover 12 is closed on the housing 10. During the closing of the cover 12 on the housing 10, the hook 124 of the engaging module 14 and the latch 142 of the sliding member 140 are in point contact. During the process of closing the cover 12 on the housing 10, the hook 124 of the engaging module 14 and the latch 142 of the sliding member 140 are in surface contact. Therefore, in order to minimize the generation of uneven friction between the hook 124 of the engaging module 14 and the latch 142 of the sliding member 140, the hook 124 of the engaging module 14 can further include a guiding angle 124c, as shown in FIG. 2A to FIG. 2E.

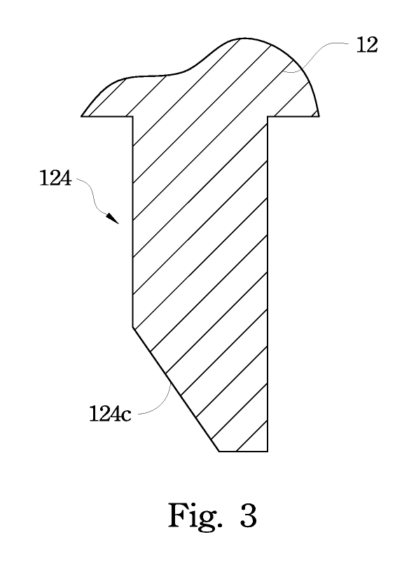

FIG. 3 is a sectional view of the hook 124 in FIG. 2A taken along line 3-3.

As shown in FIG. 2A and FIG. 3, the guiding angle 124c is formed at the edge of the fourth guiding surface 124a for reducing the friction between the fourth guiding surface 124a and the latch 142. When the guiding angle 124c is formed on the hook 124, the time point at which the hook 124 makes contact to the latch 142 of the sliding member 140 will be delayed. With the same angle of rotation, the hook 124 without the guiding angle 124c would have already contacted the latch 142 of the sliding member 140, while the hook 124 having the guiding angle 124c would not have contacted the latch 142. Therefore, the time point of contact of the hook 124 having the guiding angle 124c relative to the latch 142 is delayed, such that the problem of uneven friction is overcome.

According to the foregoing recitations of the embodiments of the invention, it can be seen that guiding surfaces that are capable of sliding relative to each other (i.e., the first guiding surface of the latch slides relative to the third guiding surface of the cover, and the fourth guiding surface of the hook slides relative to the second guiding surface of the latch) are disposed between the cover and the engaging module, and a component force generated from the guiding surfaces can make a sliding member of the engaging module move to an opening position or a closing position. Through such a configuration, the cover locks to or is released from the housing in a smooth and precise manner. Moreover, the engaging module of the invention has a simple structure that not only saves space, but also is easy to use and improves controlling performance and convenience (during operation with a single hand).

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An engaging module for engaging a cover to a housing, the housing having a sliding chute, the sliding chute being extended along a direction, the engaging module comprising:
a sliding member being slidable between an opening position and a closing position in the sliding chute, the sliding member comprising a latch, the latch comprising a first guiding surface and a second guiding surface, wherein when the cover is engaged to the housing, the sliding member can be moved to the opening position along the direction to make the first guiding surface of the latch push the cover to separate from the housing; and
a hook, disposed on the cover, comprising a trough, wherein the cover can be engaged to the housing by pushing the hook toward the second guiding surface, moving the sliding member out of the closing position along the direction, and then moving the sliding member toward the closing position so that the latch is engaged to the trough.

2. The engaging module of claim 1, wherein the cover further comprises a third guiding surface and a retaining portion, the first guiding surface is parallel to the third guiding surface, the first guiding surface of the latch is capable of pushing the third guiding surface and making the third guiding surface slide relative to the first guiding surface, so that the first guiding surface pushes the cover to separate from the housing, and the latch abuts against the retaining portion so that the sliding member is located at the opening position.

3. The engaging module of claim 1, wherein the hook further comprises a fourth guiding surface, the fourth guiding surface is parallel to the second guiding surface, and the fourth guiding surface of the hook pushes the second guiding surface to make the second guiding surface slide relative to the fourth guiding surface, so as to make the sliding member move out of the closing position along the direction.

4. The engaging module of claim 3, wherein a side of the cover is pivotally connected to the housing.

5. The engaging module of claim 4, wherein the hook further comprises a guiding angle formed at the edge of the fourth guiding surface.

6. The engaging module of claim 1, further comprising a resilient member, disposed between the housing and the sliding member, for pushing the sliding member, so that the sliding member is located at the closing position.

7. The engaging module of claim 6, wherein the resilient member is a spring.

8. The engaging module of claim 1, further comprising a pushing button disposed on the sliding member.

9. An engaging module for engaging a cover to a housing, the housing having a sliding chute, the sliding chute being extended along a direction, a side of the cover being pivotally connected to the housing, the engaging module comprising:
a sliding member being slidable between an opening position and a closing position in the sliding chute, the sliding member comprising a latch, the latch comprising a first guiding surface and a second guiding surface;
a third guiding surface disposed on the cover, wherein when the cover is engaged to the housing, the sliding member can be moved to the opening position along the direction to make the first guiding surface of the latch push the third guiding surface so as to push the cover to separate from the housing, and the first guiding surface is parallel to the third guiding surface;
a retaining portion, disposed on the cover, the latch abutting against the retaining portion, so that the sliding member is located at the opening position;
a resilient member, disposed in the sliding chute between the housing and the sliding member, for pushing the sliding member, so that the sliding member is located at the closing position; and
a hook, disposed on the cover, comprising:
a fourth guiding surface, wherein the cover can be engaged to the housing by pushing the fourth guiding surface of the hook toward the second guiding surface and moving the sliding member out of the closing position along the direction, and the fourth guiding surface is parallel to the second guiding surface;
a trough, wherein the sliding member moves toward the closing position to make the latch be engaged to the trough after the cover is engaged to the housing; and
a guiding angle, disposed at the edge of the fourth guiding surface, for reducing the friction between the fourth guiding surface and the second guiding surface.
